(19) United States
(12) Patent Application Publication
(10) Pub. No.: US 2006/0158481 A1
(43) Pub. Date: Jul. 20, 2006

(54) Method and system for multi-channel ink-jet printing

(75) Inventors: Larry M. Spevak, Great Falls, VA (US); Kevin C. Currier, Pembroke, NH (US); Michael A. Syverson, Allenstown, NH (US); Gregory P. Francke, Gilford, NH (US)

Correspondence Address: LAW OFFICE OF JAMES TROSINO, 92 NATOMA STREET, SUITE 211, SAN FRANCISCO, CA, 94105, US

(73) Assignee: VUTEK, Incorporated, Meredith, NH (US)

(21) Appl. No.: 11/039,359

(22) Filed: Jan. 19, 2005

(51) Int. Cl. B41J 2/21

(52) U.S. Cl. 347/43

(57) ABSTRACT

A printing apparatus having an array of printheads arranged along a single printhead axis, and capable of printing images and a coating layer on the substrate during a single printing operation. The coating layer can comprise a specialized printing fluid such as a layer of substantially white ink. The apparatus can perform a pre-coat printing operation, in which the coating layer is deposited first on the substrate, and the image is then printed over the coating layer. The apparatus can also perform a post-coat printing operation, in which the image is first printed onto the substrate, and the coating layer is then deposited over the image. The printhead array includes at least one printhead for printing inks to form the images, and at least one printhead for printing a specialized fluid to form the coating layer. Depending on the printing mode, a controller allocates certain nozzles of the array for printing inks and certain nozzles for printing the specialized fluid. As each section of a substrate advances under the array, it first receives a coating layer, and then an image layer; or it first receives an image layer and then a coating layer. The invention is particularly advantageous for printing on non-white and transparent substrates, as well as for printing backlit signs.

### BACKGROUND OF THE INVENTION

Certain types of printing systems are adapted for printing images on large-scale printing media, such as for museum displays, billboards, sails, bus boards, and banners. Some of these systems use so-called drop on demand ink jet printing. In these systems, a piezoelectric vibrator applies pressure to an ink reservoir of the printhead to force the ink out through the nozzle orifices positioned on the underside of the printheads. A set of print heads are typically arranged in a row along a single axis within a printhead carriage. As the carriage scans back and forth along the direction of the printhead axis, the print heads deposit ink across the width of the substrate. A particular image is created by controlling the order at which ink is ejected from the various nozzle orifices.

Some of these systems use inks with different colors to create the desired image. For instance, black, yellow, cyan, and magenta colored inks are commonly employed alone or in combination to generate the image. Thus combinations of these four base colors are used to create various other colors. For instance, a green region of the image is produced by depositing a yellow layer of ink and a cyan layer of ink.

The inks used in these systems are typically “subtractive”-type inks, meaning that as ambient (i.e., white) light passes through the image, each different ink, or combination of inks, “subtracts” light of certain characteristic wavelengths, so that an observer views each respective ink or combination of inks on the substrate as having a particular color (e.g., yellow, cyan, magenta, etc.). Because of this, it is generally required that the images to be printed on a white or near-white background—such as on a white substrate—to assure that an observer will see the proper colors in the final printed image. Otherwise, colors from behind the ink pattern can interfere with the colors of the inks and distort the image seen by the observer.

Accordingly, in order to print color images on non-white substrates, such as colored or transparent substrates, it is typically necessary to lay down a layer of solid white ink to serve as a backdrop for the color inks. For instance, in order to print a multi-colored image on a black or colored substrate, the area of the substrate on which the image is to be printed is first pre-coated with a layer of white ink, and then the image is printed on top of the solid white pre-coat layer. The white background layer prevents the colors in the image from being distorted by the back or colored substrate.

When printing on a transparent substrate, the color inks are typically applied on the reverse side of the substrate, so that the image can be viewed through the front side of the substrate. Then, a layer of solid white ink is printed over the color ink pattern in what is known as a “post-coating” step. The solid white “post coat” layer serves as a backdrop so that the colors of the image appear properly when viewed from the front side of the transparent substrate. Typically, the transparent substrate is then laminated onto a second transparent substrate, such as a window, so that the color image is protected between the two transparent substrates.

One drawback to the existing techniques for ink-jet printing on non-white substrates is that they require a separate “pre-coating” or “post-coating” step. These additional steps can be performed on a separate printing system configured to print a layer of solid white ink, but this is an extremely time-consuming and costly solution. Alternatively, there are some ink jet printing systems that are capable of performing the “pre-coating” or “post-coating” steps by providing a pair of separate, dedicated printheads for printing white ink onto the substrate. One example of such a system is the Rho 160W printer from Durst Phototechnik AG, of Brixen, Italy. In these systems, dedicated printheads are located adjacent to the leading and trailing edges of the main printhead array for depositing a layer of solid white ink onto the substrate either prior to, or subsequent to, the main printing operation. An example of this type of printing system is shown schematically in FIG. 3. One disadvantage to this type of system is that the printhead carriage must be made larger to accommodate the dedicated pre-coat and post-coat printheads, which are located outside of the main axis of color ink printheads. Also, these extra printheads are relatively expensive, and can add significant costs to the printing system.

### SUMMARY OF THE INVENTION

A printing apparatus of the invention comprises an array of printheads arranged along a single printhead axis, and can print both images and a coating layer on the substrate during a single printing operation. The coating layer can comprise a specialized printing fluid such as, for example, a layer of substantially white ink. The apparatus can perform a pre-coat printing operation, in which the coating layer is deposited first on the substrate, and the image is then printed over the coating layer. The apparatus can also perform a post-coat printing operation, in which the image is first printed onto the substrate, and the coating layer is then deposited over the image. The coating layer can also be applied on the substrate, in between two image layers, which can be useful for printing backlit signs, for instance.

The invention advantageously uses a conventional printhead array, in which all the printheads are arranged along a single printhead axis. In a preferred embodiment, the printhead array is housed in a carriage that scans across the width of a substrate as the substrate advances underneath the printheads. The printhead array includes two groups of printheads, including a first group for printing inks, preferably multi-colored inks, onto the substrate to form images, and a second group, which may comprise just one printhead, for printing a specialized printing fluid, such as white ink, onto the substrate.

A controller controls the printhead array to operate in at least three different modes: a multi-channel pre-coat mode, a multi-channel post-coat mode, and a single-channel printing mode. In the multi-channel pre-coat mode, the controller causes a first set of nozzles on the first group of printheads to deposit inks onto the substrate, and a second set of nozzles from the second group of printheads to deposit a coating fluid, such as white ink, onto the substrate. In this mode, the second set of nozzles depositing the coating fluid are located adjacent to the leading edge of the substrate, and the first set of nozzles depositing inks are adjacent to the trailing edge of the substrate, as the substrate advances under the print heads. Thus, each successive section of the substrate first receives a coating layer from the second (leading) group of nozzles, and the image is then printed over the coating layer using the first (trailing) group of nozzles. Accordingly, the printing system is able to deposit both the pre-coat layer, and the image layer on top of the pre-coat layer, using a single printhead array arranged along a single axis, during a single printing operation.

Similarly, in the multi-channel post-coat mode, the controller causes a first set of nozzles on the first group of printheads to deposit inks onto the substrate, and a second set of nozzles from the second group of printheads to deposit a coating fluid, such as white ink, onto the substrate. In this mode, however, the first set of nozzles depositing the inks are located adjacent to the leading edge of the substrate, and the second set of nozzles depositing the coating layer are adjacent to the trailing edge of the substrate, as the substrate advances under the print heads. Thus, each successive section of the substrate first receives an image layer from the first (leading) group of nozzles, and the coating layer is then applied over image by the second (trailing) group of nozzles. Accordingly, the printing system is able to simultaneously deposit both the image layer, and the post-coat layer, using a single printhead array arranged along a single axis, during a single printing operation.

The invention is also capable of operating in a standard, single-channel print mode, in which all the nozzles of the first group of printheads are used to print images in a conventional manner.

The present invention is advantageous in that it allows for both pre-coating and post-coating operations using a conventional printhead arrangement, in which all of the printheads are aligned along a single axis. Thus, the carriage holding the printheads can be made smaller as compared to similar printing systems for providing pre-coat and post-coat operations. Moreover, because the specialized printhead for providing the pre-coat and post-coat layers is arranged in-line with the conventional image-printing heads, a single print head can be used to provide both pre-coat and post-coat printing operations, which was not possible with existing systems.

The invention also relates to a method of printing on a substrate which comprises printing an ink pattern on the substrate using a first set of nozzles from a first print head and printing a coating layer on the substrate using a second set of nozzles from a second print head, the first and second printheads being arranged in a printhead array along a single printhead axis.

In another aspect, the invention relates to a method of printing an image for a backlit sign, as well as to backlit signs produced according to this technique, the method comprising printing a first ink pattern onto a substrate using a first set of nozzles from a first print head; printing a coating layer over the first ink pattern using a second set of nozzles from a second print head, the first and second printheads being arranged in a printhead array along a single printhead axis; and printing a second ink pattern over the coating layer using a third set of nozzles from the first print head.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a printing system in accordance with the invention;

FIG. 2 is a top view of a carriage of the printing system of FIG. 1 holding a series of print heads;

FIG. 3 is a top view of a carriage holding a series of print heads according to a prior art printing system;

FIG. 4 is a bottom view of the carriage of FIG. 2;

FIG. 5 is a bottom view of a series of print heads schematically illustrating a multi-channel pre-coat printing mode;

FIG. 6. is a bottom view of a series of print heads schematically illustrating a multi-channel post-coat printing mode;

FIG. 7 is a bottom view of a series of print heads schematically illustrating a single-channel printing mode;

FIG. 8 is a schematic diagram of a control system of the invention;

FIG. 9 is a flow diagram showing methods of printing according to the invention;

FIG. 10 is a bottom view of a series of print heads schematically illustrating a multi-channel printing mode for printing a backlit sign;

FIG. 11 is a cross-sectional side view of a backlit sign produced according to the printing mode of FIG. 10; and

FIG. 12 is a cross-sectional side view of a prior art backlit sign.

### DETAILED DESCRIPTION OF THE INVENTION

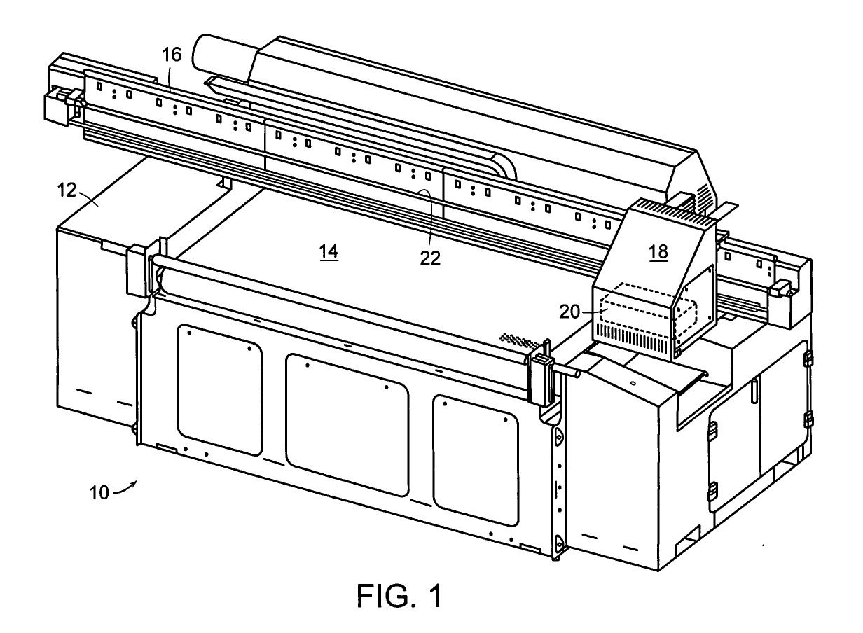

A description of preferred embodiments of the invention follows. Turning now to the drawings, there is shown in FIG. 1 a printing system 10 provided with a carriage 18. The carriage 18 holds a series of ink jet print heads 20 configured for printing images on a variety of substrates. Typical substrates are polyvinyl chloride (PVC) and reinforced vinyl. The printing system 10 is able to print on flexible as well as on non-flexible substrates, such as, for example, metals, glass, and plastics. The inks deposited can be solvent-based inks, or radiation (e.g. UV) curable inks used, for example, in printing systems described in U.S. Pat. No. 6,457,823 and U.S. application Ser. No. 10/172,761, filed Jun. 13, 2002, the entire teachings of which are incorporated herein by reference.

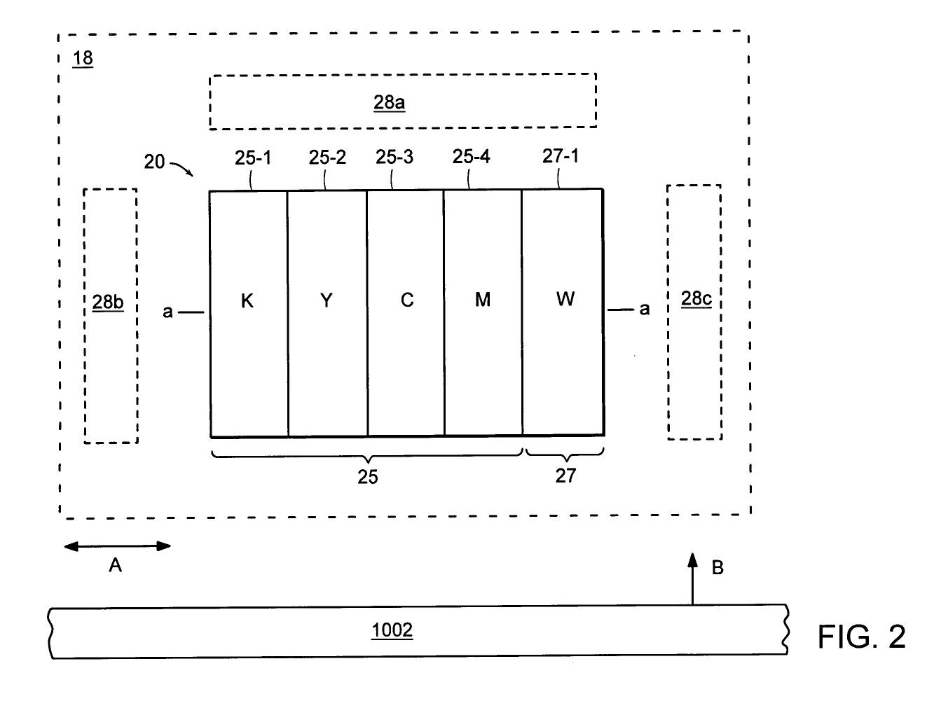

In addition to the carriage 18, the printing system 10 includes a base 12, a transport belt 14 which moves a substrate positioned on top of the belt 14 through the printing system 10, and a rail system 16 attached to the base 12. The carriage 18 is attached to a belt 22 which is wrapped around a pair of pulleys positioned on either end of the rail system 16. A carriage motor is coupled to one of the pulleys and rotates the pulley during the printing process. Accordingly, as the transport belt 14 intermittently moves the substrate 1002 (see FIG. 2) underneath the carriage 18, and hence the series of print heads 20, the pulleys translate the rotary motion of the motor to a linear motion of the belt 22 thereby causing the carriage 18 to traverse back and forth along the rail system 16 across the substrate 1002 as the series of ink print heads 20 deposit ink onto the substrate 1002. More particularly, as illustrated in FIG. 2, the carriage 18 moves back and forth as indicated by the arrow A as the substrate 1002 moves intermittently in the direction of arrow B underneath the print heads 20.

There is illustrated in FIG. 2 one example of the physical arrangement of the series of print heads 20 as they are mounted in the carriage 18. The series of print heads 20 generally comprises two groups of print heads 25, 27, comprising two separate printing channels. The first group of print heads 25, comprising the first printing channel, includes a series of printheads for printing multi-colored images using colored inks. In the embodiment shown in FIG. 2, the first group of print heads 25 includes four printheads, 25-1, 25-2, 25-3 and 25-4, for printing black (K), yellow (Y), cyan (C), and magenta (M) inks, respectively. In practice, the first group of printheads 25 will typically include more the four printheads shown. For example, the first group of printheads 25 may include eight print heads, with pairs of printheads for printing each of the black (K), yellow (Y), cyan (C), and magenta (M) inks, respectively. In other embodiments, the first group of printheads 25 can include sixteen printheads, divided into sub-groups of four printheads each for printing each of the four different colored inks. Some examples of suitable arrangements for the first group of printheads 25 are provided in U.S. patent application Ser. No. 10/281,292, filed on Oct. 24, 2002, the entire teachings of which are incorporated herein by reference. In some embodiments, the first group of print heads 25 can include additional printheads, or sub-sets of print heads, for depositing more than four colors. Examples of such systems are described in U.S. Pat. No. 6,786,578 to Aschman et al., the entire teachings of which are incorporated herein by reference. It will also be understood that the first group of printheads 25 can include less than four printheads, and can print images using less than the four colors shown.

The second group of print heads 27, comprising the second printing channel, is made up of at lease one printhead 27-1 for depositing at least one specialized printing fluid onto the substrate that is different from the multi-colored inks deposited by the first group of printheads 25. In the embodiment of FIG. 2, print head 27-1 is used to deposit solid white ink (W) onto the substrate, such as utilized in a “pre-coating” or “post-coating” printing step, as described in further detail below. It will be understood that the second group of printheads 27 can include more than one printhead, and could included a set of printheads for depositing a printing fluid. In addition, it will be understood that instead of, or in addition to white ink, the second group of printheads can deposit other printing fluids and combinations of such fluids onto the substrate, such as clear protective coatings, anti-graffiti coatings, adhesives, gloss coatings, and anti-gloss coatings.

As shown in FIG. 2, the first group 25 and the second group 27 of printheads are positioned adjacent to one another in carriage 18, and aligned along an axis, a-a, that is essentially parallel to the direction of arrow A, which is the direction of travel of carriage 18. The carriage 18 may also contain, or have associated with it, one or more radiation sources 28, such as a UV lamp or an LED source, to partially or fully cure the inks or other printing fluids after they are deposited onto the substrate. For example, radiation source 28a (shown in phantom in FIG. 2) could be located adjacent to the trailing edge of the series of printheads 20 for applying radiation to the deposited fluids as the substrate 1002 moves through the system. Similarly, radiation sources 28b, 28c (shown in phantom in FIG. 2) could be positioned laterally adjacent to the series of printheads 20 for partially or fully curing the deposited fluids. Examples of printing systems having radiation sources are described in the aforementioned U.S. Pat. No. 6,457,823 and U.S. application Ser. No. 10/172,761, filed Jun. 13, 2002, which are incorporated herein by reference.

The arrangement shown in FIG. 2 advantageously allows for sequential, multi-channel printing operations using a single series of printheads 20 aligned along a single printhead axis, a-a. For example, the printing system of the invention is easily adaptable to perform both a “pre-coat”step when printing on non-white substrates, and a “post-coat” step when printing on transparent substrates. As described previously, both “pre-coating” and “post-coating” operations involve the deposition of a layer of solid white ink to serve as a backdrop for the color inks, and thus properly balance the colors of the image, when viewed by an observer. In a “pre-coating” step, which may be required, for instance, when printing a multi-colored image on a black or colored substrate, the area of the substrate on which the image is to be printed is first pre-coated with a layer of solid white ink, and then the image is printed on top of the solid white pre-coat layer. In a “post-coating” step, which may be required, for instance, when printing a multi-colored image on a transparent substrate, the color inks are typically applied first on the reverse side of the substrate, and then a layer of solid white ink is printed over the color ink pattern to serve as a backdrop when the color image is viewed through the front side of the substrate. In both of these operations, as in other similar multi-channel printing operations, it is critical that the color image printing and the pre- or post-coating steps be performed sequentially and independently of one another. In other words, the printed image and any coating layer(s) cannot be laid down simultaneously on the same portion of the substrate, or else the respective printing fluids will mix together and ruin the image as well as the coating layer(s).

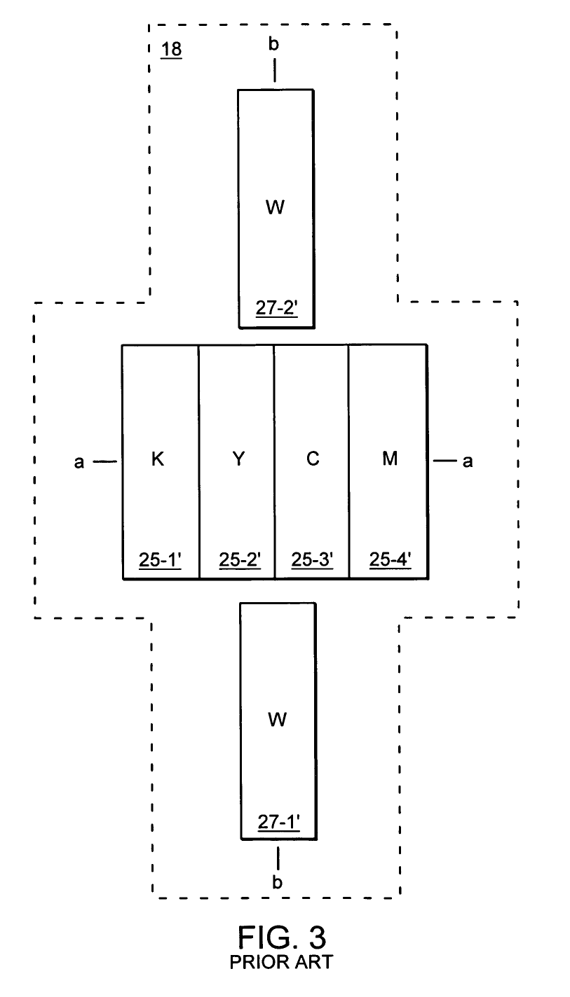

Referring to FIG. 3, there is depicted, for illustration purposes, an example of a prior known printhead arrangement for performing “pre-coat” and “post-coat” printing operations. In this system, like in the system of FIG. 2, a printhead carriage 18′ holds a series of printheads 20′ comprising a first group of printheads 25′, including printheads 25-1′, 25-2′, 25-3′, 25-4′, for depositing colored inks (i.e., black (K), yellow (Y), cyan (C), and magenta (M), respectively) to form multi-colored images on a substrate. The printheads of the first group 25′ are arranged adjacent to one another in carriage 18′, and aligned along an axis, a-a, that is essentially parallel to the direction of travel of carriage 18. A second group of pintheads 27′ consists of printheads 27-1′ and 27-2′ which deposit solid white ink (W) onto the substrate in a “pre-coating” or “post-coating” operation. However, unlike in the arrangement of FIG. 2, printhead 27-1′ is not aligned with the first group of printheads 25′ along axis a-a, but is instead disposed adjacent to the leading edge of the first group of printheads 25′ along axis b-b. Printhead 27-1′ can only deposit fluid on the substrate prior to the formation of the color image in a pre-coat operation. Similarly, printhead 27-2′ is not aligned with the color ink printheads along axis a-a, but is disposed adjacent to the trailing edge of printheads 25′ along axis b-b. Printhead 27-1′ can only deposit fluid on the substrate subsequent to the formation of the color image in a post coat operation. Thus, in the prior systems, two separate dedicated printheads, or sets of printheads, are required in order to perform both pre-coating and post-coating operations. Since printheads are expensive components of printing systems, this arrangement can significantly increase the cost of the printing system. Moreover, since the two printheads 27-1′, 27-2′ are not arranged in-line with the color ink heads along axis a-a, but are instead arranged orthogonal to the other heads along axis b-b, the printhead carriage 18′ must be made substantially larger to accommodate these additional heads, as well as any related components, such as a radiation source (see 28a in FIG. 2) for curing inks.

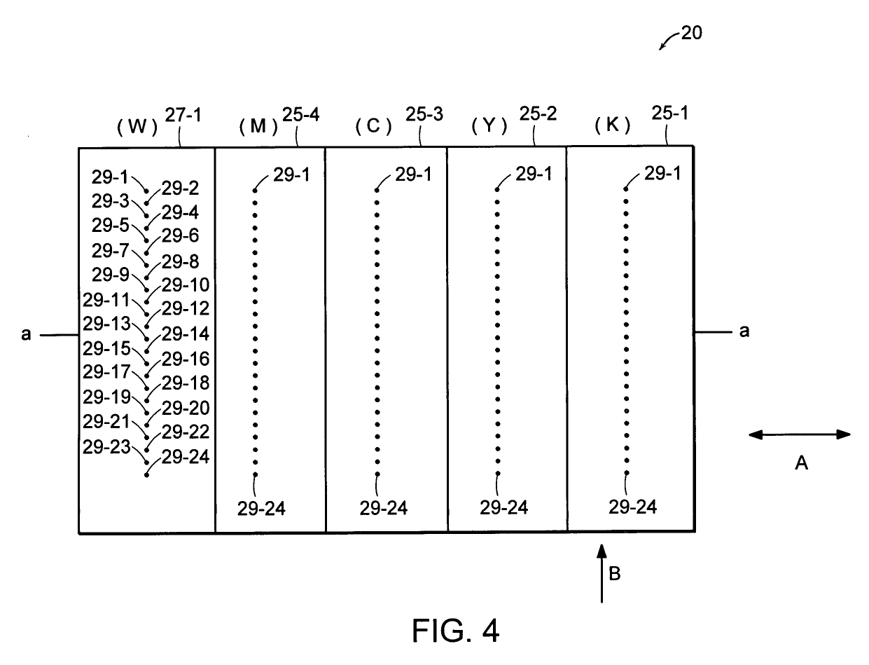

By way of the arrangement illustrated in FIG. 2, and the printing method described below, the present invention is advantageously capable of performing both pre-coating and post-coating operations using a single series of printheads 20 aligned along a single axis, a-a, that is substantially parallel to the direction of motion of the carriage. To more clearly illustrate the method of the present invention, FIG. 4 depicts the underside of the printhead carriage 18 of FIG. 2. Each of the printheads, 25-1, 25-2, 25-3, 25-4, 27-1, includes a row of nozzles 29 running along the length of the printhead. A typical printhead can include a row of 256 uniformly-spaced nozzles, with a spacing of about 4/360 of an inch between adjacent nozzles. Typically, a printing system will include a set of printheads for depositing ink of each color, with each printhead in the set slightly offset from the others in order to increase the resolution of the printing system. (For instance, in a system using four printheads per ink color, an offset of 1/360th of an inch between each head provides a resolution of 360 dpi). For purposes of illustration, only five printheads are shown in FIG. 3, one for each different color ink (i.e. white (W), magenta (M), cyan (C), yellow (Y), black (K)), and each printhead includes only twenty-four nozzles (indicated as 29-1 through 29-24 in FIG. 4).

During a printing operation, the substrate moves under printheads in the direction of arrow B, as the carriage 18 holding the printheads scans across the substrate in the direction of arrow A. A controller (not shown) actuates the printheads to selectively eject ink droplets from the nozzles 29 to deposit printing fluids on the substrate in a pre-determined pattern. According to the present invention, the controller is adapted to operate the printing system in at least three modes: a multi-channel pre-coat mode, a multi-channel post-coat mode, and a single-channel printing mode.

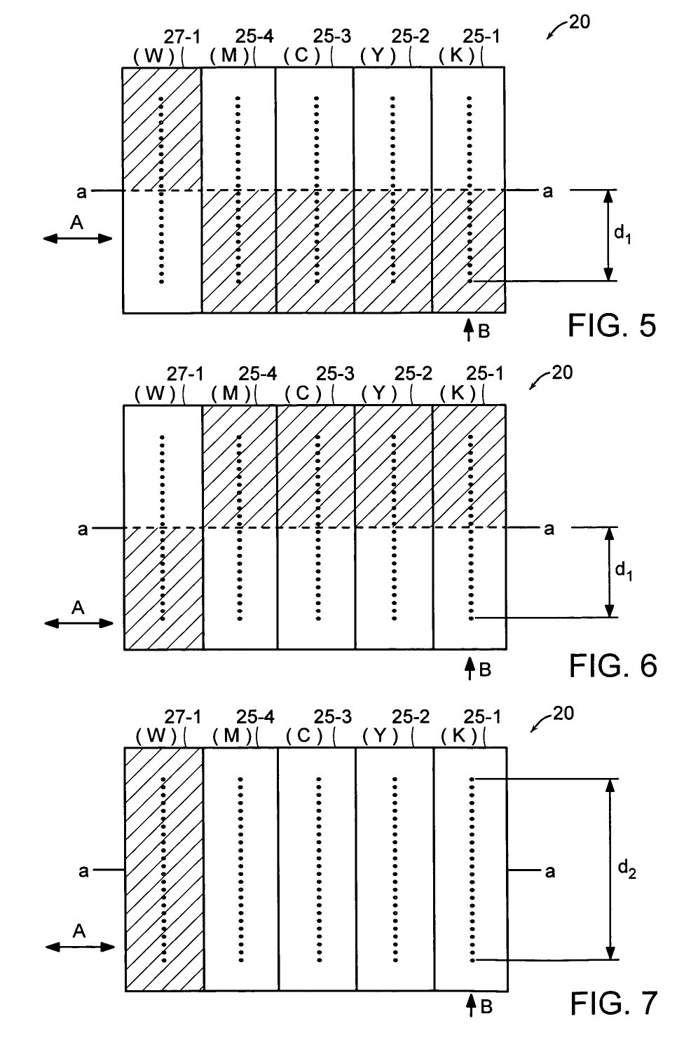

The multi-channel pre-coat mode is illustrated schematically in FIG. 5. In this mode, as the carriage 18 scans across the substrate along the direction of arrow A, the controller causes ink to eject from the nozzles of the non-hatched regions of color ink printheads 25-1, 25-2, 25-3 and 25-4, and white ink printhead 27, but no ink is ejected from the hatched regions of these heads. Accordingly, as the substrate moves along the direction of arrow B, it will first receive a layer of solid white ink from half the nozzles of printhead 27 (i.e. nozzles 29-13 through 29-24). Then, as the carriage scans back across the substrate and the substrate incremented by distance d₁ along direction of arrow B, the trailing nozzles (i.e., nozzles 29-1 through 29-12) of color ink printheads 25-1 through 25-4 print a pattern of color inks over the layer of solid white ink, while the leading nozzles 29-13 through 29-24 of printhead 27 deposit a layer of solid white ink on the next section of the substrate to pass under the heads. This process is repeated until the entire pre-coating layer of white ink, and the entire color ink print image on top of the pre-coat layer, are formed on the substrate. It will be understood that, if necessary, a radiation source can be arranged to partially or fully cure each region of white ink and/or each region of color inks, as they are deposited. Accordingly, the printing system is able to simultaneously deposit both the pre-coat layer, and the color image layer on top of the pre-coat layer, using a single printhead array 20 arranged along a single axis, a-a. This mode is particularly advantageous for printing images on black or color substrates, where the pre-coat layer provides a solid white backing to improve the appearance of the color image.

It will be understood that although the embodiment of FIG. 5 shows half of the nozzles of printhead 27 as performing the pre-coat step, and half of the nozzles of the color ink printheads 25-1 through 25-4 as performing the color printing step, this exact percentage is not necessary. What is required for the pre-coat mode is that some percentage of the nozzles adjacent to the leading edge of the substrate as it moves through the system are dedicated to the pre-coating operation, while the remaining nozzles are employed to print color inks over the pre-coated sections of the substrate.

The multi-channel post-coat mode is illustrated schematically in FIG. 6. In this mode, as in the pre-coat mode, as the carriage 18 scans across the substrate along the direction of arrow A, the controller causes ink to eject from the nozzles of the non-hatched regions of color ink printheads 25-1, 25-2, 25-3 and 25-4, and white ink printhead 27, but no ink is ejected from the hatched regions of these heads. Note, however, that in the post-coat mode, the hatched and un-hatched regions are reversed relative to FIG. 5. Accordingly, as the substrate moves along the direction of arrow B, it will first receive a pattern of color ink from nozzles 29-13 through 29-24 of color printheads 25-1 through 25-4. Then, as the carriage scans back across the substrate and the substrate incremented by distance d, along direction of arrow B, the trailing nozzles (i.e., nozzles 29-1 through 29-12) of printhead 27 deposit a layer of solid white ink over the pattern of color ink, while the leading nozzles 29-13 through 29-24 of the color printheads deposit color inks on the next section of the substrate to pass under the heads. This process is repeated until the entire color ink print image, and the post-coat layer on top of the image, are formed on the substrate. As with the pre-coat mode of FIG. 5, it will be understood that, if necessary, a radiation source can be arranged to partially or fully cure each region of color ink and/or each region of white ink, as they are deposited. Accordingly, the printing system is able to simultaneously deposit both the color image layer, and the white post-coat layer on top of the image layer, using a single printhead array 20 arranged along a single axis, a-a. This mode is particularly advantageous for printing images on transparent substrates, where the post-coat layer provides a solid white backing to improve the appearance of the color image when viewed through the transparent substrate.

It will be understood that although the embodiment of FIG. 6 shows half of the nozzles of printheads 25-1 through 25-4 as printing color inks, and half of the nozzles of printhead 27 as performing the post-coat step, this exact percentage is not necessary. What is required for the post-coat mode is that some percentage of the color printhead nozzles adjacent to the leading edge of the substrate as it moves through the system are dedicated to the color printing operation, while the remaining percentage of nozzles of printhead 27 are employed to print a post-coat layer over the color images.

The single-channel printing mode is illustrated schematically in FIG. 7. In this mode, as the carriage 18 scans across the substrate along the direction of arrow A, the controller causes ink to eject from all of the nozzles of the (unhatched) color ink printheads 25-1, 25-2, 25-3 and 25-4, but no ink is ejected from hatched printhead 27. Accordingly, as the substrate moves along the direction of arrow B, and the carriage 18 scans across the substrate, the substrate can receive color ink from any of nozzles 29-1 through 29-24 of the color printheads 25. Then, as the carriage scans back across the substrate, the substrate can be incremented by distance d₂ along direction of arrow B, and the color printheads can deposit a new region of color ink on the next section of the substrate to pass under the heads. This process is repeated until the entire print image is formed on the substrate. If necessary, a radiation source can be arranged to partially or fully cure each region of color inks as they are deposited on the substrate. Accordingly, in the single-channel mode, the printing system is able to utilize all the available nozzles of the color printheads to print color images in a conventional manner. This mode is useful for printing images on white or near-white substrates, where a pre-coat or post-coat layer is not necessary, and, because all of the color ink nozzles are used in this mode, the images can be printed faster than in the multi-channel modes.

It will be understood that in a single-channel mode, instead of printing with the first group of color ink printheads 25, the printhead could print using only the printhead(s) of the second group 27, in order to print a layer or pattern of white ink on the substrate, for example. Furthermore, the printing system could utilize the printheads of the second group 27 in conjunction with the printheads of the first group 25 in forming the color image. For example, printhead 27 could be selectively connected to a reservoir holding a color ink (e.g., magenta, yellow, cyan, black, or another color) during single-channel printing operations to add an extra color printhead.

In addition, although the embodiments of FIGS. 5-7 describe the substrate being incremented by a full distance of d₁ in the case of FIGS. 5 and 6, and d₂ in the case of FIG. 7, between each subsequent pass of the carriage 18, it will be understood that the substrate can advance in fractions of these increments for multi-pass printing operations, as are known in the art.

Moreover, although the embodiments illustrated herein show the second group of printheads 27 as comprising a single printhead, it will be understood that additional printheads can be added to the second group. This can help improve the speed of the multi-channel printing operations, and in the case of pre-coating and post-coating operations, can improve the opacity of the solid white coating layers.

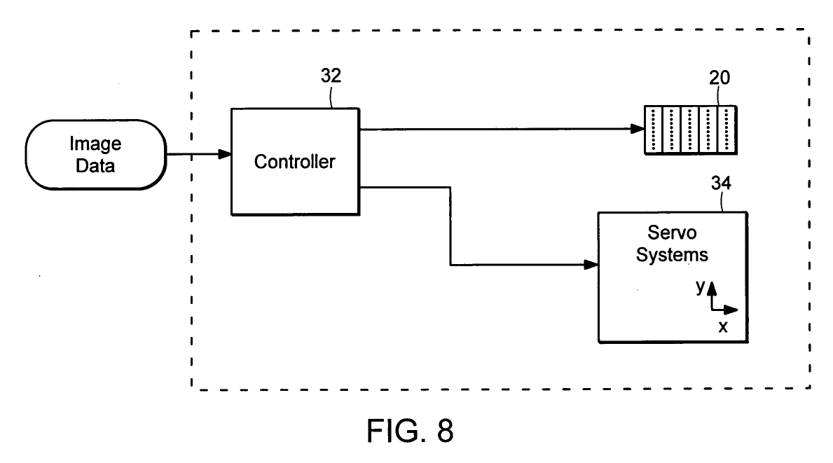

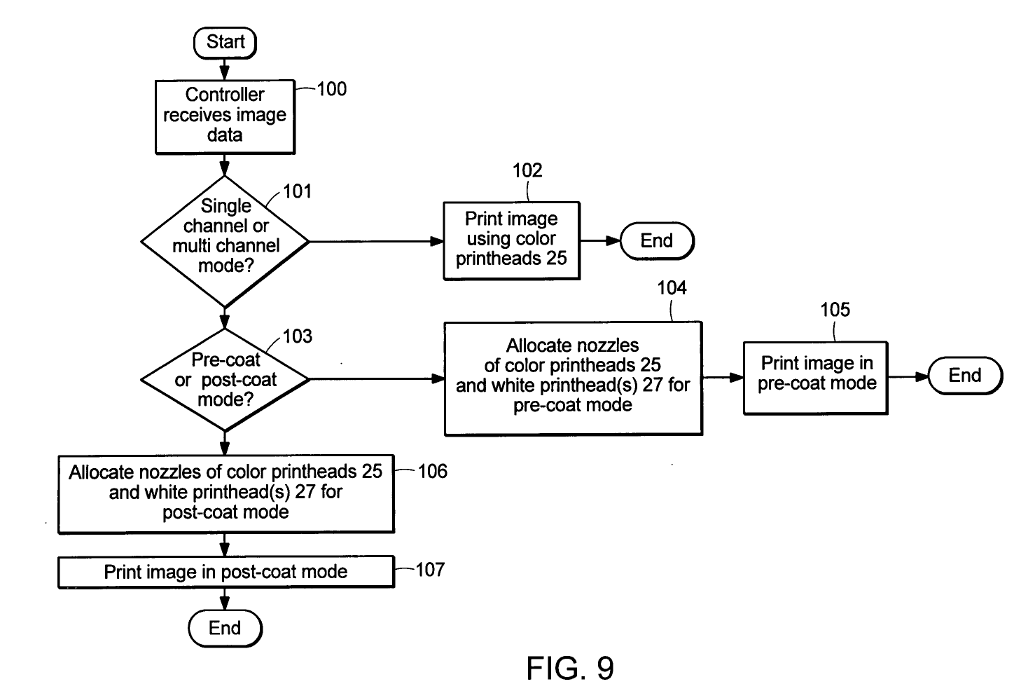

Turning now to FIGS. 8 and 9, a control system 30, and a method of printing according to the present invention are illustrated. As shown in FIG. 8, the control system 30 includes a controller 32 which controls a series of printheads 20 to eject inks from specific nozzles at specific times, and servo systems 34 for controlling the (x-y) position of the printheads relative to a substrate. The printheads 20 are made up of a first group of printheads 25 for printing conventional color inks, and one or more printheads 27 for depositing a specialized printing fluid, which could be, for example, solid white ink. The controller receives image data 36 for an image to be printed on the substrate, and based upon this data, coordinates the operation of the printheads 20 and servo systems 34 to produce the desired image on the substrate.

A method of printing using control system 30 is illustrated in the flow diagram of FIG. 9. At step 100, the controller receives the image data 36 corresponding to the image to be printed on a substrate. The image data 36 can include additional information about the printing operation, such as the type of substrate being used, or whether a single-channel or multi-channel printing mode is to be employed. At step 101, the controller determines whether to print the image using a normal, single-channel mode (such as described in connection with FIG. 7, above), or a multi-channel mode (such as described in FIGS. 5 and 6, above). If the controller determines that the image is to be printed using a normal, single-channel mode, then the controller proceeds with a conventional printing operation at step 102, using all of the nozzles of the color ink printheads 25 of printhead array 20.

If, however, the controller determines that the image is to be printed using a multi-channel mode, then at step 103, the controller determines whether to use a pre-coat mode, or a post-coat mode. If it is a pre-coat mode, then at step 104, the controller allocates a select portion of nozzles of the color ink printheads 25 for printing color inks, and a select portion of the nozzles of the specialized fluid printhead(s) 27 for printing the specialized printing fluid. In a pre-coat mode, typically about one-half of the nozzles of the specialized printhead(s) 27 located closest to the leading edge of the substrate are allocated to print the specialized fluid, and about one-half of the nozzles of the color ink printheads 25 located closest to the trailing edge of the substrate are allocated to print color ink. The controller then proceeds to step 105, and controls the printheads 20 and servo systems 34 to deposit the pre-coat and image layers.

If, however, the controller at step 103 determines that a post-coat mode is to be used, then at step 106 the controller allocates a select portion of nozzles of the color ink printheads 25 for printing color inks, and a select portion of the nozzles of the specialized fluid printhead(s) 27 for printing the specialized printing fluid. In a post-coat mode, typically about one-half of the nozzles of the color ink printheads 25 located closest to the leading edge of the substrate are allocated to print the specialized fluid, and about one-half of the nozzles of the specialized printhead(s) 27 located closest to the trailing edge of the substrate are allocated to print the specialized fluid. The controller then proceeds to step 107, and controls the printheads 20 and servo systems 34 to deposit the image and post-coat layers.

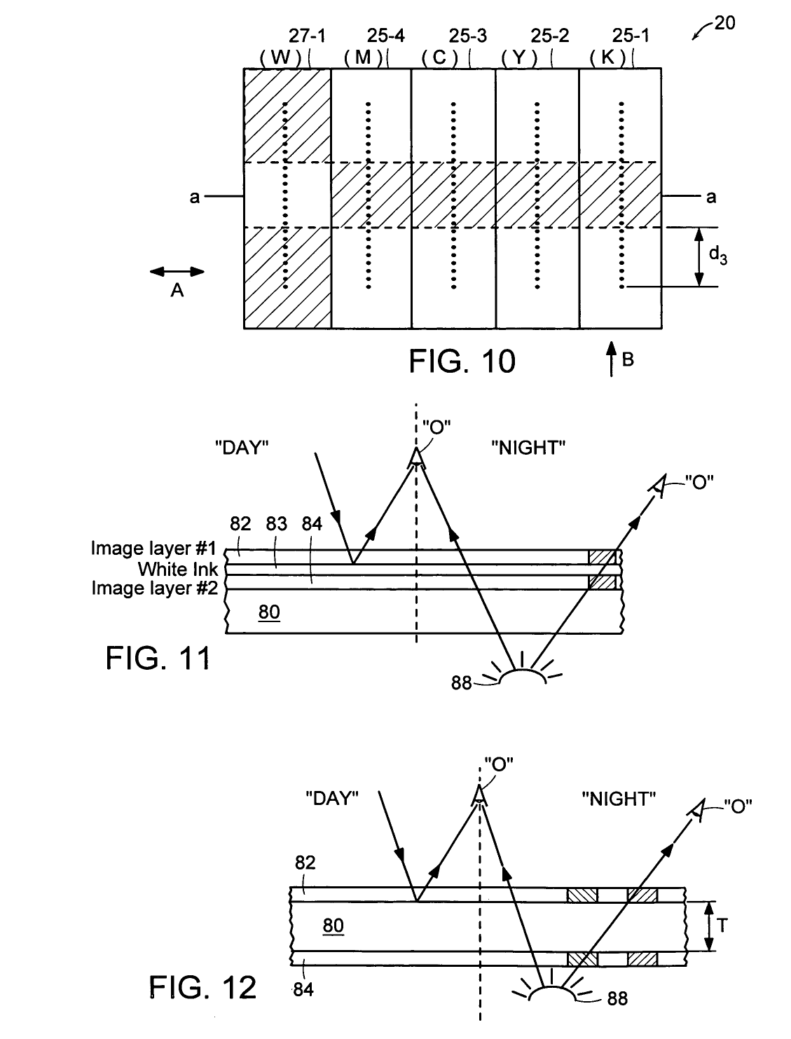

FIGS. 10-11 illustrate yet another multi-channel printing mode of the invention that is particularly advantageous for printing images on backlit signs. As shown in FIG. 12, conventional backlit signs typically utilize a white, partially opaque substrate 80 having an image printed on, or laminated on, both the front 82 and rear 84 faces of the substrate. During daylight hours, or whenever there is sufficient ambient light, an observer (O) views the image on the front side 82 of the substrate. However, at night, or when there is insufficient ambient light, a backlight 88 shines light through the image formed on the rear face 84 of the substrate (which is typically a mirror image of the image on the front side 82), as well as the image on the front side 82 of the substrate, to be viewed by the observer (O). There are several deficiencies with this type of backlit sign. First, the image on the front side 82 of the substrate must be precisely aligned and registered with its mirror image 84 on the back side, or else the backlit image will appear fuzzy or distorted to an observer. Proper alignment of the two images can be difficult, for example, if one or both of the images are laminated onto the substrate 80. Moreover, because the substrate has a finite thickness (T), even properly-aligned features on the front 82 and back 84 sides of the substrate will appear fuzzy to an observer (O′) who views the backlit sign from the side, as illustrated in FIG. 12.

The present invention is able to overcome these deficiencies by providing a multi-channel printing mode for printing a backlit sign. To more clearly illustrate this embodiment of the present invention, FIG. 10 depicts the underside of the printhead carriage 18 of FIG. 2. In this printing mode, as the carriage 18 scans across the substrate along the direction of arrow A, the controller causes ink to eject from the nozzles of the non-hatched regions of color ink printheads 25-1, 25-2, 25-3 and 25-4, and white ink printhead 27, but no ink is ejected from the hatched regions of these heads. Notably, in this mode, both the leading portion and the trailing portion of the nozzles of the color ink pintheads 25 are used for printing color images, while only the middle portion of the nozzles of the white ink printhead 27 is used to apply a solid white coating layer. Accordingly, as the substrate moves along the direction of arrow B, it will first receive a color image layer from the leading third of the nozzles of color ink printhead 25 (i.e. nozzles 29-17 through 29-24). Then, as the carriage scans back across the substrate and the substrate incremented by distance d₃ along direction of arrow B, the middle nozzles (i.e., nozzles 29-9 through 29-16) of printhead 27 deposits a layer of solid white ink over the color inks, while the leading third of nozzles 29-17 through 29-24 of printheads 25 deposit another color image layer on the next section of the substrate to pass under the heads. Next, as the carriage scans again across the substrate, and the substrate is again incremented by distance d₃, the trailing third of nozzles (i.e., nozzles 29-1 through 29-8) of color printheads 25 deposits a color image layer over both the solid white coating layer and the original color image layer, while the middle third of nozzles of printhead 27, and the leading third of nozzles of the color printheads 25, deposit a solid white coating layer and a color image layer, respectively. This process is repeated until the entire color image layer is printed twice on the substrate, with an intermediate coating layer of solid white ink sandwiched between the two color image layers. A cross-section of a backlit sign produced according to this printing mode is shown in FIG. 11. An advantage of this arrangement is that the intermediate layer between the “front” 82 and “rear” 84 images of the backlit sign consists only of a relatively thin layer of white ink 83, instead of the comparatively thicker substrate 80, as shown in the prior art sign of FIG. 12. Thus, this design greatly reduces the problem of “fuzzy” images when the backlit sign is viewed from the side. Moreover, because both the “front” 82 and “rear” 84 images are formed simultaneously during the same printing operation, using the same printheads, the two images can be precisely aligned with one another on the substrate, thus eliminating the problem of fuzzy and distorted images as in conventional signs shown in FIG. 12.

While this invention has been particularly shown and described with references to preferred embodiments thereof, it will be understood by those skilled in the art that various changes in form and details may be made therein without departing from the scope of the invention encompassed by the appended claims.

1. A printing apparatus for printing images on a substrate, comprising:
an array of printheads arranged along a printhead axis and adapted to print an image on the substrate using at least one ink, and a coating layer on the substrate using a specialized printing fluid that is different from the at least one ink.

2. The apparatus of claim 1, wherein the coating layer is deposited prior to the printing of the image in a pre-coating step.

3. The apparatus of claim 1, wherein the coating layer is deposited subsequent to the printing of the image in a post-coating step.

4. The apparatus of claim 1, wherein the coating layer is deposited subsequent to the printing of a first image layer on the substrate, and prior to the printing of a second image layer over the coating layer and the first image layer.

5. The apparatus of claim 1, wherein the specialized printing fluid of the coating layer comprises a substantially white ink.

6. The apparatus of claim 1, wherein the substrate comprises a substantially transparent substrate.

7. The apparatus of claim 1, wherein the substrate comprises a substantially non-white substrate.

8. The apparatus of claim 1, wherein the image is printed using a plurality of different colored inks.

9. The apparatus of claim 8, wherein the colors of the inks include at least one of cyan, magenta, yellow and black.

10. The apparatus of claim 1, wherein the coating layer comprises at least one of a clear protective coating, an anti-graffiti coating, an adhesive, a gloss coating and an anti-gloss coating.

11. A printing apparatus for printing images on a substrate, comprising:
an array of printheads arranged along a printhead axis, each printhead in the array comprising a series of printhead nozzles for selectively depositing a printing fluid onto the substrate, the array comprising
a first set of printheads having at least one print head arranged to deposit ink onto the substrate to form an image on the substrate; and
a second set of print heads having at least one print head arranged to deposit a specialized printing fluid on the substrate; and
a controller which controls the operation of the printheads to cause the first set of printheads to print an image layer from a first group of printhead nozzles, and the second set of printheads to print a coating layer of the specialized printing fluid from a second group of printhead nozzles.

12. The printing apparatus of claim 11, wherein the coating layer is deposited prior to the image layer being formed over the coating layer.

13. The printing apparatus of claim 12, wherein the first group of nozzles is positioned adjacent to a trailing edge of the substrate, and the second group of nozzles is positioned adjacent to a leading edge of the substrate, as the substrate moves underneath the printheads.

14. The printing apparatus of claim 11, wherein the coating layer is deposited subsequent to, and on top of, the image layer.

15. The printing apparatus of claim 14, wherein the first group of nozzles is positioned adjacent to a leading edge of the substrate, and the second group of nozzles is positioned adjacent to a trailing edge of the substrate, as the substrate moves underneath the printheads.

16. The printing apparatus of claim 11, wherein the specialized printing fluid comprises substantially white ink.

17. The printing apparatus of claim 11, wherein the specialized printing fluid comprises at least one of a clear protective coating, an anti-graffiti coating, an adhesive, a gloss coating and an anti-gloss coating.

18. The printing apparatus of claim 11, wherein the first group of print heads comprises at least two print heads for depositing different colored inks.

19. The printing apparatus of claim 18, wherein the different colored inks include at least two of magenta, cyan, yellow and black inks.

20. The printing apparatus of claim 18, wherein the first group of print heads comprises at least four print heads, each print head depositing a different colored ink.

21. The printing apparatus of claim 20, wherein the first group of print heads comprises at least four sets of print heads, each set of print heads depositing a different colored ink.

22. The printing apparatus of claim 11, wherein the second group of print heads comprises one print head.

23. The printing apparatus of claim 11, wherein the second group of print heads comprises more than one printhead.

24. The printing apparatus of claim 11, wherein the ink comprises radiation-curable ink.

25. The printing apparatus of claim 24, further comprising a radiation source located adjacent to the print heads for applying radiation to the radiation-curable ink.

26. The printing apparatus of claim 11, further comprising a print head carriage for housing the array of printheads.

27. The printing apparatus of claim 26, wherein the carriage scans across the substrate for depositing printing fluid on the substrate.

28. The printing apparatus of claim 27, wherein the carriage scans in a direction that is essentially parallel to the print head axis.

29. The printing apparatus of claim 28, further comprising a system for moving the substrate under the print heads in a direction that is substantially perpendicular to the print head axis.

30. The printing apparatus of claim 11, wherein the substrate comprises a substantially non-white substrate.

31. The printing apparatus of claim 11, wherein the substrate comprises a substantially transparent substrate.

32. The printing apparatus of claim 11, wherein the controller causes the first set of printheads to print an image layer from a first group and a third group of printhead nozzles, and the second set of printheads to print a coating layer of the specialized printing fluid from a second group of printhead nozzles, such that the coating layer is formed between two image layers on the substrate.

33. The printing system of claim 11, wherein the controller is adapted to control the printheads to print in a standard printing mode wherein all the nozzles of the first group of printheads are used to print an image layer, and the specialized printing fluid is not deposited.

34. A method of printing on a substrate, comprising:
printing an ink pattern on the substrate using a first set of nozzles from a first print head;
printing a coating layer on the substrate using a second set of nozzles from a second print head, the first and second printheads being arranged in a printhead array along a single printhead axis.

35. The method of claim 34, wherein the coating layer is printed prior to the printing of the ink pattern in a pre-coating step.

36. The method of claim 35, wherein first set of nozzles are adjacent to a trailing edge of the substrate, and the second set of nozzles are adjacent to a leading edge of the substrate, as the substrate moves under the print heads.

37. The method of claim 34, wherein the coating layer is printed subsequent to the printing of the image in a post-coating step.

38. The method of claim 37, wherein the first set of nozzles are adjacent to a trailing edge of the substrate, and the second set of nozzles are adjacent to a leading edge of the substrate, as the substrate moves under the print heads.

39. The method of claim 34, wherein the coating layer is printed subsequent to the printing of a first ink pattern, and prior to the printing of a second ink pattern over the coating layer and the first ink pattern.

40. The method of claim 34, wherein the specialized printing fluid of the coating layer comprises a substantially white ink.

41. The method of claim 34, wherein the substrate comprises a substantially transparent substrate.

42. The method of claim 34, wherein the substrate comprises a substantially non-white substrate.

43. The method of claim 34, wherein the ink pattern is printed using a plurality of different print heads using a plurality of different colored inks.

44. The method of claim 43, wherein the colors of the inks include at least one of cyan, magenta, yellow and black.

45. The method of claim 34, wherein the coating layer comprises at least one of a clear protective coating, an anti-graffiti coating, an adhesive, a gloss coating and an anti-gloss coating.

46-48. (canceled)
